(19) United States
(12) Patent Application Publication
(10) Pub. No.: US 2021/0404204 A1
(43) Pub. Date: Dec. 30, 2021

(54) MASS DAMPER FOR DAMPING VIBRATIONS OF A STRUCTURE, STRUCTURE WITH SUCH A MASS DAMPER AND METHOD FOR ADJUSTING THE NATURAL FREQUENCY OF A MASS DAMPER

(71) Applicant: MAURER ENGINEERING GMBH, München (DE)

(72) Inventor: Johann DISTL, Unterhaching (DE)

(21) Appl. No.: 17/289,854

(22) PCT Filed: Nov. 7, 2019
(86) PCT No.: PCT/EP2019/080587

§ 371 Date: Apr. 29, 2021

(30) Foreign Application Priority Data
Nov. 7, 2018 (DE) 10 2018 218 999.4

(51) Int. Cl. E04H 9/02; E04B 1/98; F16F 7/10

(52) U.S. Cl. CPC E04H 9/0215; F16F 7/1022; E04B 1/98

(57) ABSTRACT

The present invention refers to a mass damper for reducing vibrations of a structure with a pendulum mass and a damping means, wherein the mass damper has at least three bearings with which the pendulum mass is movably supported on the structure such that it can execute pendulum movements and each of the bearings has at least one pendulum plate with a concave bearing surface and a sliding shoe arranged movably thereon with a convex counter surface. In accordance with the invention, the bearing surfaces and the associated counter surfaces are curved with a constant radius of curvature R and all bearings have a lowest possible friction between the counter surface and the bearing surface. The invention also extends to a structure with such a mass damper and a method for adjusting the natural frequency of a mass damper, in which the natural frequency of the pendulum mass can be adjusted independently of one another in both main directions by displacing and/or rotating the pendulum plates. The invention also extends to the damping means, which can be implemented with linear viscous passive damping, with square viscous passive damping or with controlled damping, in order to tune this damping together with the friction damping of the bearings to the optimum damping of the mass damper.

The present invention refers to a mass damper for reducing vibrations of a structure, a structure with such a mass damper and a method for adjusting the natural frequency of a mass damper.

Mass dampers (also known as tuned mass dampers—TMD) are used to reduce vibrations of structures. These vibrations of the structure can occur, for example, as a result of wind, earthquakes, traffic, machine movements, vibrations from the surroundings and from persons in the structure. They reduce the serviceability and comfort of the users of the structure and in extreme cases, in resonance mode, can lead to the collapse of the structure. This can and should be avoided by the use of mass dampers.

Various types of mass dampers have already been proposed. The types of construction already differ in whether vibrations in vertical (e.g. mass-spring oscillator) or horizontal (e.g. pendulum mass) direction are to be reduced. At any case, a mass damper has an oscillatory mass (oscillator).

For the reduction of horizontal vibrations of a structure, as they can result from changing wind loads (gusty wind), the simplest design is a pendulum mass suspended from a rope or rod, for example, which reduces horizontal vibrations by its mass force (inertia force). In order for the mass damper to work as efficiently as possible, it is usually placed at the structure where the vibration amplitude is the greatest. This is often the case with tower-like structures (pylons, skyscrapers) in the highest possible area of the structure. Nevertheless, the mass force of the pendulum mass usually compensates wind power only to a large extent and not to 100%.

The tuning of the natural frequency of the pendulum mass to the natural frequency of the structure to be damped is realized via the pendulum length. The final frequency tuning on site, i.e. when the TMD is installed and the actual natural frequency of the structure is measured, is done by attaching or removing so-called tuning springs or by shortening or lengthening the pendulum mass suspension.

There is usually a damping means between the pendulum mass and the structure, for example in the form of a hydraulic damper, to generate the necessary damping of the mass damper itself. For conventional mass dampers this damping is linear and is designed according to known interpretation rules (e.g. for minimal structure acceleration). It is assumed that the damping of the entire mass damper consists only of that of the damping means and besides no friction exists in any bearings or bearings of the suspensions.

A TMD in pendulum design can act as a physical pendulum if, for example, the pendulum mass is suspended by only one rope or pendulum rod and thus the inertial effect of the suspended mass consists of both a translational component (primary effect) of the pendulum mass and the rotational inertia (secondary effect) of the pendulum mass. If the pendulum mass is suspended by pendulum rods with joints or by ropes in the form of a transverse pendulum, the pendulum mass only oscillates translatorically, so that the vibration reduction is based solely on this inertia component.

The advantage of suspended pendulum masses is the very low influence of friction in the bearings of the suspension, as the small bearing diameter of the suspension in comparison to the large pendulum length reduces the effective friction force on the pendulum according to the lever law. A disadvantage of suspended pendulum masses is their relatively large overall construction height. For example, a very long pendulum length may be necessary at a low natural frequency of the structure. If the natural vibration of the structure to be damped has its natural frequency e.g. at 0.15 Hz, the optimally tuned natural frequency of the mass damper is 0.1485 Hz, if the ratio of the pendulum mass to the modal mass of the natural vibration to be damped is 2%, so that the pendulum length of the transverse pendulum is 11.26 m. If the natural frequency of the structure to be damped is e.g. 0.12 Hz, the optimally tuned pendulum length is 17.16 m. Such long pendulum lengths mean that the entire mass damper requires several floors for its installation, which brings economic disadvantages for the owner of the structure.

A further disadvantage of suspended pendulum masses, in particular of transverse pendulums, is the fatigue load on the suspension, which can be very large or difficult to estimate due to the large pendulum masses of up to 1500 tons and the notch effect on the ropes at their suspension points. Under such circumstances, it may be necessary to secure the structure against the fall and/or lateral impact of the pendulum mass with a separate fall and/or impact safety device. In addition to the already large construction height, there is also a reserve which is dimensioned such that the pendulum length, which was optimally tuned to the natural frequency assumed in the planning stage, can be optimally tuned to the measured natural frequency of the structure after installation of the mass damper. For this purpose, devices are provided in the pendulum suspension that allow the pendulum length to be shortened or lengthened, depending on whether the measured natural frequency is higher or lower than assumed in the planning. In addition to the disadvantage of the large installation height, the suspension of large pendulum masses requires either a massive reinforcement of the ceiling, where the mass is suspended, or an additional steel frame for the suspension must be built, which is supported on the floor, but which requires even more space in the vertical direction.

For this reason, various designs have been proposed in the past to reduce the installation height of such TMDs. With the nested pendulum two pendulums are built into each other, whereby the total installation height can be reduced to approx. ⅔ of the installation height of a normal pendulum. The installation height cannot be reduced significantly below ⅔ because the suspension construction of the two nested pendulums also requires vertical space.

Another method to reduce the installation height is the combination of a normal pendulum with an inverted pendulum, where usually the pendulum mass of the inverted pendulum is smaller than the pendulum mass of the normal pendulum. The inverted pendulum generates a negative stiffness force on the normal pendulum, which results in the natural frequency of the two coupled pendulums being lower than one would expect from the pendulum length of the normal pendulum. Conversely, this means that the pendulum length of the normal pendulum is reduced and measured so that the natural frequency of the coupled pendulums (suspended and inverted pendulum) corresponds to the optimally tuned natural frequency of the mass damper.

Another well-known method of reducing the pendulum length is to incline the suspension ropes so that the distance of the suspension at the structure is greater than the distance of the attachment of the pendulum mass, and so that the ropes are attached to the pendulum mass below its center of gravity so that the pendulum mass performs a tilting movement in addition to the transverse movement. Thus, the center of gravity of the pendulum mass moves on a larger radius than the radius of the rope suspension, which corresponds to a lower natural frequency of the pendulum. Therefore, a certain natural frequency of the mass damper can be achieved with a suspension length that is smaller than the suspension length of a normal pendulum with vertical ropes.

The frequency tuning of these systems described here is no longer done only by the extension or the shortening of the pendulum length, but by changing various geometric parameters (rope lengths, mass dimensions, rope angles, rope pivot points at the pendulum mass, etc.).

A major disadvantage of all these systems, however, is that they are all very complex in design and therefore costly. They also save height, but require additional space in the floor plan. They also generally show non-linear system behavior in terms of natural frequency and damping of the mass damper, which is detrimental to vibration reduction efficiency.

Another major disadvantage of coupled pendulums are geometric conflicts between the suspension of the normal pendulum and the pendulum supports of the inverted pendulum. The concept of inclined ropes only works if the ropes react elastically, but this is associated with high alternating load shares in the ropes and thus also with high peak forces in the ropes.

A further concept to reduce the installation height is to mount the pendulum mass on a horizontal slide plane, but this does not result in an oscillatory system. Therefore, with a horizontal slide bearing of the mass, additional springs must be attached between the mass and the structure in order to produce a oscillatory mass. A frequency adjustment is achieved here by replacing the springs with those having a different spring rate. However, in case of a large pendulum mass and low natural frequency of the mass damper, many and very soft springs with large spring deflections are required, which is technically and economically complex. If the mass damper has to be designed such that the vibrations of the structure are reduced in both main directions of the plane (x- and y-direction), the frequency adjustment by means of springs in both main directions becomes more complicated, because as a rule structures show different natural frequencies in both main directions, which also means that the optimal natural frequencies of the mass damper are different in both main directions. A further disadvantage is the friction of the horizontal slide plane, which can be so large that the pendulum mass does not slide at all during wind excitation of the structure, whereby the mass damper loses its effect completely and the structure vibrates as if it had no mass damper at all. It should also be noted that the usually high friction of such horizontal slide planes leads to a non-linear damping, which means that this non-linear damping can only be optimized for a certain amplitude of the relative displacement of the pendulum mass; with smaller amplitudes the friction damping is too large, with larger amplitudes the friction damping is too small.

Finally, with EP 2 227 606 B1, a mass damper concept has been proposed in which the pendulum mass can oscillate on slide bearings with curved bearing surfaces, which minimizes the installation height similar to horizontal bearings. With the mass damper concept according to EP 2 227 606 B1, the entire damping of the mass damper is produced only by the friction properties of the slide bearings, without the use of additional hydraulic dampers. This means that the friction of the slide bearings can only be optimized for a certain displacement amplitude of the pendulum mass, since friction damping is non-linear and thus amplitude-dependent. In the mass damper concept according to EP 2 227 606 B1, the radius of curvature of the slide surfaces of the bearings can also be varied transversely to the sliding direction. The radius of curvature thus increases from the inside to the outside. According to EP 2 227 606 B1, the natural frequency of the pendulum mass is tuned by displacing the pendulum plates of the bearings transversely to the direction of movement of the pendulum mass so that the pendulum mass slides on a curve with a different radius of curvature and thus a different pendulum frequency is set. The disadvantage is that when the surface-resting sliding shoe is moved, it cannot easily adapt to the changed curvature of the pendulum plate. This leads to edge pressure and plasticizing of the sliding material.

Therefore, an object of the invention is to provide a mass damper for damping vibrations of a structure with a pendulum mass and a damping means, which minimizes the installation height and therefore has at least three bearings with which the pendulum mass is supported movably on the structure such that it can execute pendulum movements, but whose natural frequency can be adjusted much more easily and whose damping properties are much easier to control than with the mass damper of EP 2 227 606 B1.

The solution for the object of the invention is achieved device-related with a mass damper in which each of the bearings has at least one pendulum plate with a concave curved bearing surface and a sliding shoe arranged movably thereon with a convex curved counter surface, wherein each sliding shoe for its part is articulately fastened to the pendulum mass, and which is now characterized precisely by the fact that for all bearings, the bearing surfaces and the associated counter surfaces are curved with a constant radius of curvature and all bearings have a lowest possible friction between the counter surface and the bearing surface.

Thus, the approach according to the invention is based firstly on the knowledge that the curvature of the bearing surfaces and the associated counter surfaces is best done with a constant radius and not with a variable radius transverse to the direction of movement. This is because the mass damper according to the invention has a linear behavior in this way. A further consequence of the constant radius of curvature is that the counter surface of the sliding shoe always fully rests on the bearing surface, regardless of where the counter surface or the sliding shoe of the bearing is located on the bearing surface. This minimizes the friction on the slide surface and the wear of the sliding material, because a bearing surface that does not cover the entire surface of the sliding shoe increases friction and abrasion (wear).

Secondly, it is based on the knowledge that the friction in the slide bearings must be minimized so that the mass damper triggers even with the smallest wind loads and thus reduces the vibrations of the structure. So, tests of the applicant have shown that, in contrast to the teaching of EP 2 227 606 B1, all bearings have a lowest possible friction between the counter surface and the bearing surface, so that the pendulum mass even starts to slide in the case of small but frequently occurring wind excitation forces with a return period of one year or less, so that the mass damper reduces the vibrations of the structure even with small wind loads.

These two measures make it possible to optimally adjust the entire damping of the mass damper over a very large range of the displacement amplitude of the pendulum mass. In addition, this approach has the advantage that the pendulum mass does not require any fall protection, since the pendulum mass is supported on bearings and cannot fall from a greater height.

Preferably, the damping means has square viscous damping properties and preferably at least one hydraulic cylinder with such properties. As the minimized bearing friction is combined with square viscous damping, the resulting entire damping of the mass damper can be optimally adjusted over a very large amplitude range (20% to 80% of the maximum displacement amplitude). This applies in particular if the friction of the bearings cannot be neglected when adjusting the optimum damping of the mass damper.

The design of the damping means and in particular the use of at least one hydraulic cylinder with such damping properties results in the entire damping, consisting of friction damping (damping exponent α approximately 0) of the bearings and quadratic viscous damping (damping exponent α=2) of the damping means, being approximately linear (damping exponent α approximately 1) over a wide amplitude displacement range (20% to 80% of the maximum displacement amplitude) of the pendulum mass. The optimization for the almost linear entire damping of the mass damper can then be done by adjusting the viscous damping coefficient c of the damping means or of the hydraulic cylinder(s).

In addition, at least one bearing may have a starting friction between the counter surface and the bearing surface whose friction resistance φ is less than 5% of the weight force of the pendulum mass (maximum value), preferably less than 0.5% of the weight force of the pendulum mass, most preferably less than 0.25% of the weight force of the pendulum mass. This ensures that the pendulum mass begins to oscillate even at very low excitation forces, e.g. from wind, and thus counteracts the excitation force and reduces structural vibrations. The target values of 5%, 0.5% and 0.25% result from the fact that the permissible peak acceleration of residential and commercial buildings for the so-called one-year wind is typically 10/1000 g (acceleration due to gravity) or 15/1000 g, for other structures the permissible peak acceleration can also be up to 50/1000 g. If the friction is 5%, the pendulum mass begins to move at 50/1000 g peak acceleration of the structure and thus has a vibration-reducing effect, if the coefficient of friction is 0.5%, the mass damper already begins to move at 5/1000 g (half of the 10/1000 g) peak acceleration of the structure and thus has a vibration-reducing effect, and if the coefficient of friction is 0.25%, the mass damper already begins to move at 2.5/1000 g (quarter of the 10/1000 g) peak acceleration of the structure and thus has a vibration-reducing effect.

Advantageously, the radius of curvature of the bearing surfaces of the pendulum plates corresponds to the required pendulum radius of a pendulum mass of the same mass simply suspended from a rope. In other words, the radius of curvature of the bearing surfaces is selected such that the trajectory (circular path) of the pendulum mass corresponds to that of a simply suspended pendulum. This simplifies the design of the mass damper according to the invention or rather its dimensioning and considerably simplifies the frequency tuning in the structure.

Preferably, the bearing surfaces of the pendulum plates and/or the counter surfaces of the sliding shoes are curved cylindrically (circularly) and/or spherically (globularly). The choice depends on whether the pendulum mass must be able to move only in one main direction or in two main directions in the plane. In particular, the spherical curvature of the bearing surfaces and counter surfaces ensures that the pendulum mass of the mass damper can oscillate in any direction and thus reduces vibrations of the structure in any direction in the plane. On the other hand, the cylindrical curvatures of the bearing surfaces or counter surfaces have the advantage of being easier and more cost-effective to produce.

Preferably, for at least one, preferably each, of the bearings, the bearing surfaces and the associated counter surfaces are curved with the same radius of curvature. This ensures that the sliding shoe fully rests on the bearing surface in every position. It also makes sense if each of the bearings has the same radius of curvature, as this results in a clearly defined natural frequency of the pendulum mass in one direction.

Advantageously, at least one bearing has a multi-part pendulum plate, which in particular has several strip-shaped pendulum plate sections with strip-shaped partial bearing surfaces in plan view, of which preferably at least two are arranged at right angles to one another. The strip-shaped partial bearing surfaces have the advantage that they are material-saving and therefore cost-effective, especially for mass dampers with large displacement amplitudes. In addition, these bearings can be equipped with a lift-off safety device for the pendulum mass.

Preferably, a sliding shoe with two counter surfaces and a joint being between them is arranged between the two, preferably arranged at right-angles to one another, strip-shaped pendulum plate sections. Thus, the first strip-shaped pendulum plate section with the first partial bearing surface can be arranged at the bottom. The sliding shoe slides on it with its lower first counter surface. The second strip-shaped pendulum plate section can then be located above the sliding shoe. Then the sliding shoe must also have a second counter surface and a joint on its upper side. This results in a cross slide. A second sliding shoe slides on the second strip-shaped pendulum plate section, which is articulately connected to the pendulum mass on its upper side.

Preferably, at least two strip-shaped pendulum plate sections are arranged at right angles to one another. Thus, the pendulum plate can be realized in the form of a cross slide. The decoupling of the pendulum movements in two main directions (x- and y-direction) enables the natural frequencies of the pendulum mass in the two main directions of the plane to be different and thus to be optimally tuned to the generally different natural frequencies of the structure in the two horizontal main directions.

Preferably, for at least one bearing, the pendulum plate sections can be changed in their position relative to one another separately from one another. This enables the pendulum plate sections within the bearing to be positioned relatively and freely to one another in the x- or y-direction, especially with a cross slide-like configuration of the pendulum plate. Therefore, the bearing or rather its multi-part pendulum plate can be adjusted independently in its effect on the path of the mass pendulum in the x- or y-direction.

It is especially advantageous if for adjusting the natural frequency of the pendulum mass, for at least two bearings, the relative position of the respective pendulum plates and/or pendulum plate sections corresponding to one another can be changed with respect to one another. Thus, by displacing the pendulum plates of the two bearings, the natural frequency of the pendulum can be adjusted accordingly. Therefore, the two bearings or rather their pendulum plates should be aligned in the direction of movement in which the frequency is to be adjusted.

Advantageously, for at least one bearing, the pendulum plate sections can be displaced and/or tilted relative to one another so that the respective partial bearing surfaces are flush at their upper side after the displacement. This ensures that the sliding shoe of the bearing can slide in the x-direction as well as in the y-direction without jerking.

Preferably, for adjusting the natural frequency of the pendulum mass, for at least two bearings, the pendulum plates or pendulum plate sections, extending longitudinally in the direction of an axis in which the natural frequency of the pendulum movement is to be adjusted, are displaced relative to one another in the direction in which the axis extends. In contrast to the teaching of EP 2 227 606 B1, the displacement of the pendulum plates is not carried out in a direction transverse to the pendulum movement, but straight in the axis in which the pendulum movement takes place. Once this has happened, the path radius of the center of gravity of the pendulum mass in the x- and/or y-direction is no longer equal to the radius of the curved bearing surfaces in the x- and/or y-direction. This then leads to the pendulum mass oscillating with a changed natural frequency, which is adjusted to the optimum natural frequency of the mass damper.

The displacement of the radius center of the curved bearing surfaces relative to the contact points of the sliding shoes of the pendulum mass on the pendulum plates or the pendulum plate sections can take place separately towards or away from the center of gravity of the pendulum mass for the direction of movement in the x- and y-direction. In this way, a very simple and effective tuning of the natural frequencies of the pendulum mass in both directions can be achieved. This results in a frequency increase if the curved bearing surfaces or partial bearing surfaces are displaced towards the center of gravity and a frequency reduction if the curved bearing surfaces or partial bearing surfaces are displaced away from the center of gravity of the pendulum mass. In addition to the necessity of frequency adjustment, this also means that an economical gradation of radii of curvature in the production of sliding shoes and bearing surfaces or pendulum plates is possible.

Alternatively or in addition, for adjusting the natural frequency, for at least two bearings, the two pendulum plates or pendulum plate sections can be rotated relative to one another. This means that the center of the bearing surfaces or partial bearing surfaces are no longer in a vertical projection above the contact points of the pendulum mass on the pendulum plates or pendulum plate sections. The effect is then the same as when displacing the pendulum plates or pendulum plate sections. It is particularly advantageous if the rotation takes place about a radius center which is not equal to a radius center of the curved bearing surfaces. Preferably, this one is smaller.

Advantageously, at least one bearing is designed as a hydrostatic bearing. A hydrostatic bearing is a bearing in which the sliding shoe slides on a film of a liquid lubricant which is provided between the bearing surface and the counter surface.

Preferably, at least one bearing designed as a hydrostatic bearing has a pump device generating the hydrostatic effect. This can be a typical pump. However, it is also conceivable to use a pressure cartridge to force lubricant into the sliding gap between the counter surface and the bearing surface.

It is particularly useful here if at least one hydrostatic bearing is designed such that it has emergency running properties in the event of failure of the pump device generating the hydrostatic effect. This serves safety, as it ensures that the bearing does not have too high coefficients of friction even in the event of a power failure, for example, or the like. It therefore remains functional in its basic function. So, in addition to the lubricant pump, a pressure cartridge independent of the external power supply can be arranged. It is also conceivable that a sliding disc, made of a material which still has very low coefficients of friction even if the lubricant film is temporarily omitted, is provided in the counter surface of the sliding shoe.

Preferably, at least one hydrostatic bearing contributes at least temporarily to the damping of the mass damper. The pump device can also be designed such that its pumping capacity is controllable for situation-adapted adjusting of the friction of the bearing. So, the power of the pump can be controlled, preferably in real time, such that a reduced friction is generated in the bearings in case of smallest wind load conditions, while in the case of earthquake excitation or exceptionally large wind excitation, the friction in the bearings is specifically increased in order to prevent the pendulum mass from oscillating into the walls of the installation space of the mass damper, or also in order to achieve a defined friction behavior, e.g. as a function of the displacement amplitude of the pendulum mass.

Preferably, the damping means is designed such that its damping force is controllable for adjusting the generation of situation-adapted damping properties. A control is conceivable in such a way that the entire damping of the mass damper describes a predetermined behavior in function of the displacement amplitude of the pendulum mass for a certain situation (e.g. light wind, strong wind, earthquake, or the like). The damping force of the damping means can be adjusted via a corresponding control device. For example, a bypass valve or the like can be used as a control device. It is advantageous that the control takes place in real time. The control allows the entire damping to be optimally adjusted to the displacement amplitudes of the pendulum mass to be expected for the respective loads. Thus, for example, the entire damping can increase disproportionately for larger displacement amplitudes of the pendulum mass, i.e. when unusually large wind loads and/or earthquake excitation of the structure are to be expected. So, the disproportionately increasing entire damping results in an additional decelerating effect on the pendulum mass at maximum pendulum deflections and thus prevents impacts of the pendulum mass into the walls of the installation space of the mass damper, so that it can be dispensed with shock-impact damping systems. If the friction of the spherical bearings is very small thanks to the hydrostatic lubrication, i.e. less than or equal to 0.25%, linear viscous damping can also be produced in the hydraulic cylinders, so that the entire damping of the mass damper is almost optimally adjusted over a wide amplitude range (20% to 80%) of the pendulum displacement.

Alternatively or also preferably, at least one bearing is designed as a rolling bearing or as a rail-guided wheel slide. Rolling bearings are also known to have a very low starting coefficient of friction and can therefore be used well to implement the invention. On the other hand, rolling bearings have the disadvantage that they may tend to generate noise. It therefore makes sense that at least one bearing designed as a rolling bearing or as a rail-guided wheel slide has a sound insulation that ensures that the bearing emits little noise.

Preferably, the mass damper has four bearings with which the pendulum mass is supported on the structure and which are designed such that the position of the pendulum plates or of the corresponding pendulum plate sections can be changed in pairs counter-directed. It is the paired change that simplifies the adjustment of the natural frequency of the pendulum mass, even if the pendulum mass is no longer statically simply determined supported. However, four bearings simplify the tuning of the natural frequencies of the pendulum, especially in the main directions, since the adjustment of the bearing centers in the two orthogonally directed main directions can be carried out clearly and easily.

In addition, at least two bearings have a common adjusting device for displacing and/or rotating the respective pendulum plates or pendulum plate sections relative to one another. The common adjustability of the two bearings facilitates the tuning of the natural frequency of the pendulum mass and ensures that the adjustment work in both bearings is carried out simultaneously.

Preferably, the adjusting device has at least one wedge, a lining plate, an eccentric, a pendulum rod and/or an inversely curved calotte for rotating the pendulum plate or the pendulum plate section. Common to all is that the adjustment is carried out mechanically.

Additionally or alternatively, the adjusting device may also has a motor drive means for displacing and/or rotating the pendulum plates or pendulum plate sections. The motor drive means can therefore act on the wedge, the lining plates, the eccentric, the pendulum rod or also the inversely curved calotte or also act directly on the pendulum plate and/or pendulum plate sections.

The invention also refers to a structure equipped with a mass damper according to the invention. Then the damping element and the pendulum plates of the mass damper bearings are attached to the structure. Advantageously, the mass damper is placed on a floor or ceiling. Thus, the structure does not need a fall protection for the pendulum mass and also the necessary installation space for the mass damper is considerably smaller than for example in case of a structure with a normally suspended pendulum mass. And this with a comparatively simple and above all also spatially adjustable pendulum frequency of the mass damper.

Furthermore, the invention also extends to a method for adjusting the natural frequency of the mass damper of the type described above, in which the pendulum plates or the pendulum plate sections of the bearings of the mass damper are displaced in a first direction and/or rotated relative to one another until the natural frequency of the pendulum movement of the pendulum mass occurring in this first direction reaches a predetermined target value. Preferably in such a way that the natural frequency in the second main direction is not affected.

Preferably, the adjustment of the natural frequency in a second direction is then carried out by the pendulum plates or the pendulum plate sections of the bearings of the mass damper are displaced in the second direction and/or rotated relative to one another until the natural frequency of the pendulum movement of the pendulum mass occurring in this second direction reaches a predetermined target value. Preferably in such a way that the natural frequency in the first main direction is not affected. This target value does not necessarily have to correspond to the target value that should be reached in the first direction. Rather, it is possible that the natural frequencies of both directions are different, because the natural frequencies of the structure to be damped are different in both directions.

Preferably, for adjusting the natural frequency of the pendulum mass, the pendulum plates or pendulum plate sections of the bearings of the mass damper are pushed towards one another and/or rotated inwards in order to increase the natural frequency of the pendulum mass. If the natural frequency of the pendulum mass is to be reduced, the pendulum plates or the pendulum plate sections of the bearings of the mass damper are pushed apart one another and/or rotated outwards. The rotating or tilting of the pendulum plates or pendulum plate sections and the bearing surface or partial bearing surface thereon is therefore carried out alternatively or additionally to the displacement for adjusting the natural frequency of the pendulum mass. This has the advantage that a smaller change in the pendulum plate size is required and the sliding shoe can remain in the rest position in the center of the pendulum plate.

The invention also extends to the combination of friction from the bearings and square viscous damping from the damping means, particularly if this has at least one hydraulic cylinder. Thus, the entire damping of the mass damper over a wide amplitude range (20% to 80%) of the pendulum displacement is approximately linear, which finally allows optimization of the damping of the mass damper over a wide amplitude range (20% to 80%) of the pendulum displacement. Furthermore, it can be advisable to provide a disproportionately (larger than optimal for a mass damper) increasing damping if the pendulum mass oscillates with a displacement amplitude of more than 80% of its maximum value, e.g. in order to decelerate the pendulum mass more intensively at maximum pendulum amplitudes. This prevents the pendulum mass from colliding laterally with parts of the structure, such as the walls of the installation space of the mass damper, wherefore it can be dispensed with a shock-impact damping system.

In the following, the invention will be explained in more detail on the basis of embodiments shown in the drawings or figures. These show schematically:

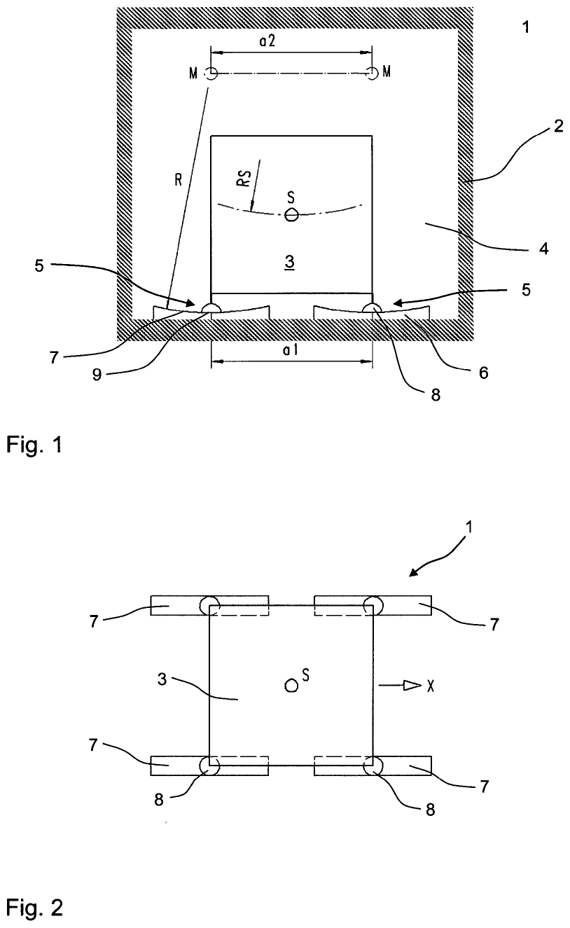

FIG. 1: a side view of a first embodiment in which the sliding shoes are centered above the pendulum plate, respectively;

FIG. 2: a top view of the first embodiment shown in FIG. 1;

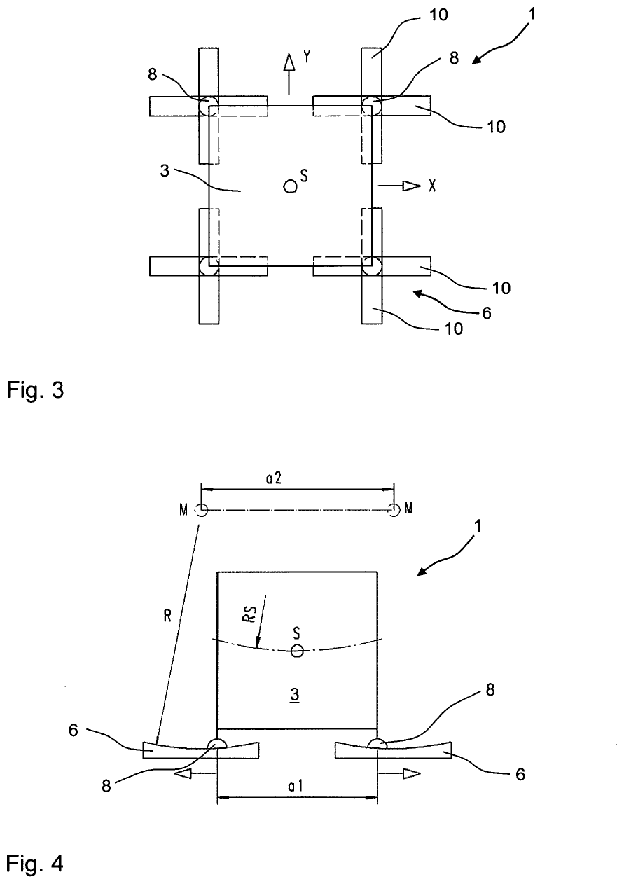

FIG. 3: a top view of a second embodiment with four pendulum plates in cross slide-like design;

FIG. 4: the embodiment shown in FIG. 1, in which the natural frequency of the pendulum mass is reduced by pushing the two pendulum plates apart one another;

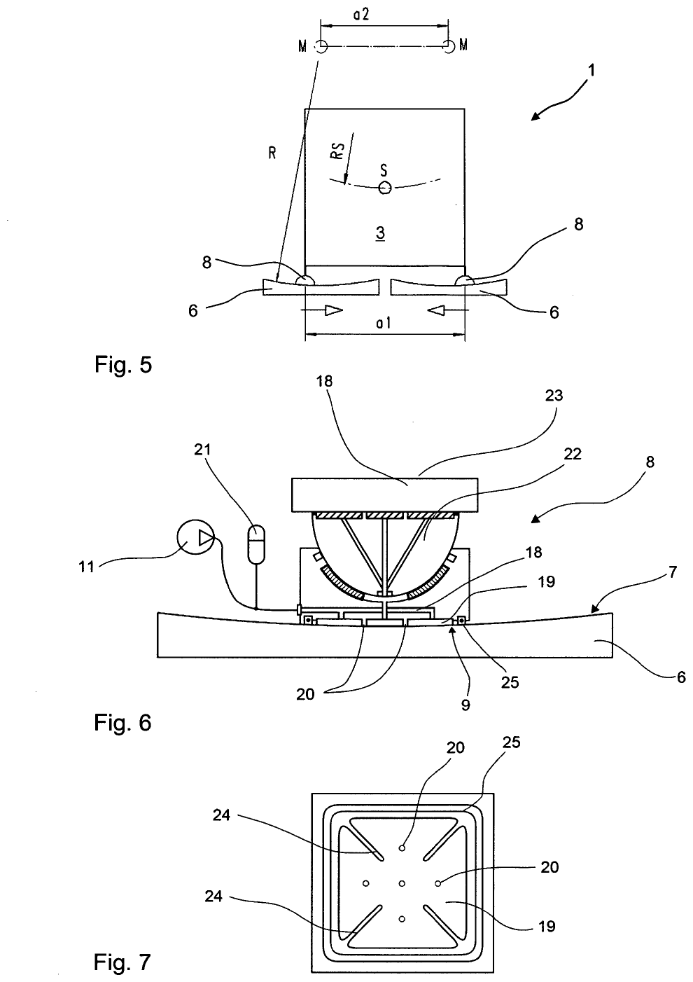

FIG. 5: the embodiment shown in FIG. 1 or FIG. 4, in which the natural frequency of the pendulum mass is increased by pushing the pendulum plates towards one another;

FIG. 6: an embodiment of a hydrostatic bearing for use in a mass damper according to the invention;

FIG. 7: a top view of the counter surface of the sliding shoe with lubrication channels and lubrication holes;

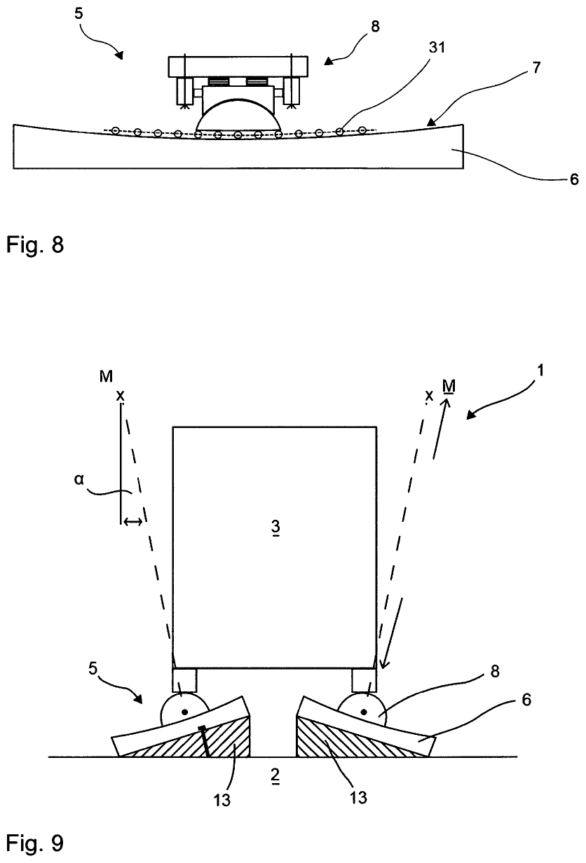

FIG. 8: an embodiment of a bearing designed as a rolling bearing for the mass damper in accordance with the invention;

FIG. 9: a third embodiment of a mass damper according to the invention with an adjusting device for mutual rotation of the pendulum plates of the bearings by means of two wedges;

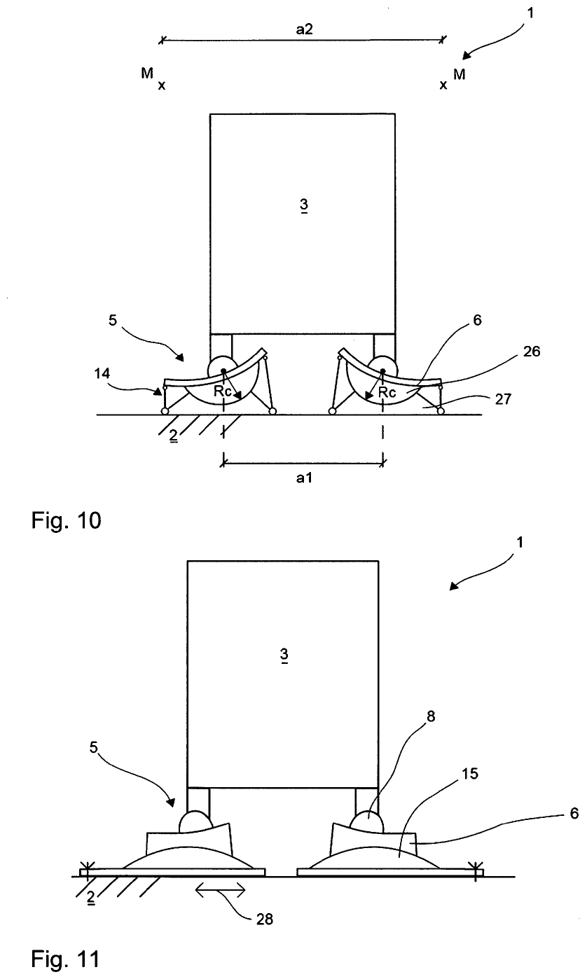

FIG. 10: a fourth embodiment of a mass damper according to the invention with an eccentric under the pendulum plates of the bearings for rotating the pendulum plates;

FIG. 11: a fifth embodiment of a mass damper according to the invention with an adjusting device having an inversely curved calotte for rotating the pendulum plate in each of the bearings;

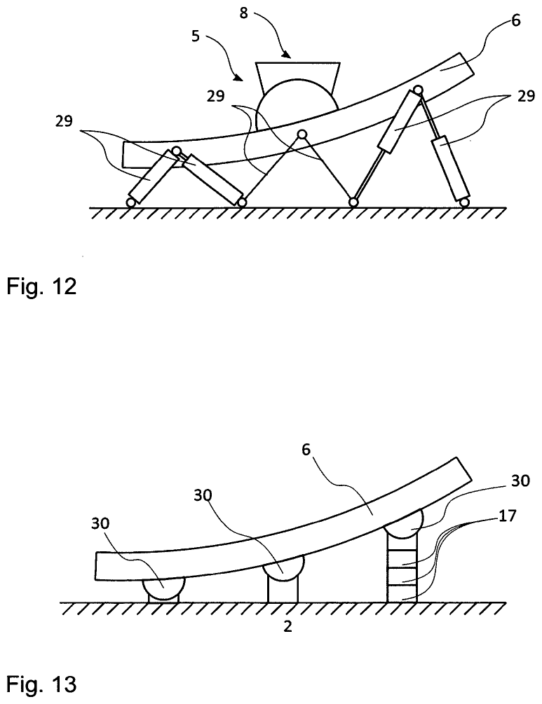

FIG. 12: another embodiment of an adjusting device for a pendulum plate in which the adjusting device comprises a plurality of variable-length pendulum rods; and

FIG. 13: an embodiment of an adjusting device for a pendulum plate using lining plates;

In the figures, identical reference numerals designate similar components even if they are used in different embodiments.

FIG. 1 shows a mass damper 1 according to the invention for reducing vibrations of a structure 2 with a pendulum mass 3 and a damping means 4. The damping means 4 is arranged between the pendulum mass 3 and the structure 2, so that the damping means 4 can work with respect to the relative movement between the pendulum mass 3 and the structure 2. Basically, a mass damper 1 according to the invention has at least three bearings 5. As can be seen in FIG. 2, the mass damper 1 shown here has four such bearings 5 on which it stands in the structure 2 on a floor of the structure 2. As already mentioned, three bearings 5 are sufficient for the basic mode of operation of the mass damper according to the invention, especially since the pendulum mass 3 is then simply statically determined supported.

The bearings 5 for their part are designed such that they support the pendulum mass 3 on the structure 2 movably so that the pendulum mass 3 can execute pendulum movements. Each of the bearings 5 has at least one pendulum plate 6 with a concave curved bearing surface 7 and a sliding shoe 8 arranged movably thereon with a convex curved counter surface 9. Each of the sliding shoes 8 for its part is articulately fastened to the pendulum mass 3.

In accordance with the invention, for all bearings 5, the bearing surfaces 7 and the associated counter surfaces 9 are curved with a constant radius of curvature R. This radius of curvature R refers to a virtual center of rotation M around which an object moving on the curved bearing surface 7 would move. In this case, this is the sliding shoe 8 of the respective bearing 5.

The arrangement of the pendulum plates 6 below the pendulum mass 3, as can be seen in FIG. 1 or FIG. 2, is a starting position as it would normally be used when mounting the mass damper 1 in the structure 2. Since the sliding shoes 8 stand central on the pendulum plate 6 or the bearing surface 7. This can also be seen from the fact that the distance between the center points of the sliding shoes or the center points of the counter surface 9 (drawn in the figure as distance a1 below the structure) corresponds to the distance between the two centers of rotation M of the two curved bearing surfaces 7 (drawn in the drawing as distance a2 above the pendulum mass 3). So, distances a1 and a2 are equal. This means that the center of gravity S of the pendulum mass 3 moves on a circular path with the radius RS, which is equal to the radius R of the curvature of the bearing surfaces 7.

The sliding shoes 8 each have counter surfaces 9 with a radius of curvature corresponding to that of the bearing surfaces 7, so that the sliding shoes 8 rest flat on the bearing surface 7. Thus, for all bearings 5, the bearing surfaces 7 and the associated counter surfaces 9 are curved with a constant radius of curvature in an exactly matched manner. In this way, the pendulum mass 3 can then perform a pendulum movement in a direction lying in plan view, which is indicated by x in FIG. 2.

According to the invention, it is important that all bearings 5 have as little friction as possible between the counter surface 9 and the bearing surface 7. The actual damping is effected via the damping means 4, which can be designed in any way, for example as a hydraulic cylinder (oil damper).

If the friction of the bearings 5 is negligibly small, the damping means 4 is designed such that it generates a linear viscous damping, which is tuned to the optimum value of the mass damper 1. If the friction of the bearings 5 is not negligibly small, the damping means 4 is designed for square viscous damping. Advantageously, this is done so that the entire damping of the mass damper in the amplitude range of the pendulum displacement of 20% to 80% of the maximum displacement amplitude is approximately linear and tuned to the optimum value. The damping of the damping means 4 or any hydraulic cylinders and/or the lubricant supply for hydrostatic bearings can also be controlled in real time in order to achieve a certain damping behavior as a function of the displacement amplitude of the pendulum mass.

In the case of a pendulum direction provided in a single direction, such as the x-direction indicated in FIG. 2, it is sufficient if the radius of curvature R of the bearing surfaces 7 of the pendulum plates 6 and/or the counter surfaces 9 of the sliding shoes 8 have a cylindrical (circular) curvature. However, if the mass damper 1 is to be able to perform pendulum movements of a spatial nature, i.e. also be effective in any direction and also be adjustable in its natural frequency in both main directions, one possibility is to form the bearing surfaces 7 of the oscillating plates 6 and the counter surfaces 9 of the sliding shoes 8 spherically (globularly). The bearing 5 can have a multi-part pendulum plate 7, as can be seen for example in FIG. 3. Here there are several strip-shaped pendulum plate sections 10 in plan view, all of which have spherically curved surfaces. They therefore have strip-shaped partial bearing surfaces on their surface, which in turn have a spherical curvature. Since all pendulum plate sections 10 and the strip-shaped partial bearing surfaces arranged on them thus have the same radius of curvature in both the x- and y-directions, it is now possible to arrange the strip-shaped partial bearing surfaces 10 at right angles to one another. The result is a multi-part pendulum plate 7 with a cross slide-like design. This has the advantage that it is considerably cheaper to produce than a pendulum plate 6 with a full surface spherical section or shell-like design.

However, if the pendulum plate sections 10 are only cylindrically curved (not shown here), the pendulum mass 3 can only be moved in one direction. To actually ensure this movement in the direction, guides must be arranged at the pendulum mass 3 or at the bearings 5 to ensure that the sliding shoes 8 of the bearings 5 do not slip off the pendulum plates 6.

If now the natural frequency of the pendulum mass 3 is to be adjusted, this is done according to the invention by displacing the pendulum plate 6 or the strip-shaped pendulum plate sections 10 of the bearings 5 apart or towards one another in the direction of the pendulum movement in whose axis the natural frequency is to be adjusted. This is indicated in FIG. 4. Here the two pendulum plates 6 are displaced apart one another. This causes the center of rotation of the respective bearing surface 7 to move outwards, so that the distance a2 becomes greater than the distance a1, as can be seen from the comparison of FIG. 1 with FIG. 4. Thus, the displacement causes a frequency adjustment in a very simple but effective way, whereby the displacement leads to the fact that the pendulum radius RS of the center of gravity S of the pendulum mass 3 is now larger than the radius of the bearing surface 7. As a result, the natural frequency decreases.

If the natural frequency is to be increased in the x-direction compared to the starting position shown in FIG. 1, according to the invention, this is done by pushing the pendulum plates 7 or the strip-shaped pendulum plate sections 10 inwards, as can be seen in FIG. 5. The result is that the radius RS of the trajectory of the center of gravity S of the pendulum mass 3 is reduced in comparison to the curvature of the pendulum plates 7.

The frequency adjustments shown in FIG. 4 or FIG. 5 can be carried out in any pendulum direction. In the cross slide-like configuration shown in FIG. 3 with multi-part pendulum plates 7 with several strip-like pendulum plate sections 10, a frequency adjustment can be carried out separately in x- and y-direction and in each direction both for increasing and decreasing the natural frequency of the pendulum mass 3. Since the partial bearing surfaces located on the pendulum plate sections 10 always have the same radius of curvature, it is also possible to ensure a flush arrangement of the bearing surface by simply displacing the pendulum plate sections 10 laterally along the other pendulum plate sections 10 orthogonally aligned to them. This prevents any protrusions or the like in the bearing surface 7.

As already explained, according to the invention, it is important that the bearings 5 have as little friction as possible in the bearing surfaces 7. One way of ensuring extremely low starting friction is to design the bearing as a hydrostatic bearing, as illustrated in FIG. 6. Such a bearing 5 has a pump device 11 with which liquid lubricant is forced into a sliding plate 19 via a channel 18 and then into the actual sliding gap between the bearing surface 7 and the counter surface 9 via holes 20. Thus, the sliding plate 19 or the sliding shoe 8 floats practically on a lubricant film, which then leads to an extremely low coefficient of friction in the bearing surface 7. It can make sense to control the pump power in real time depending on the wind load, e.g. to generate an even lower coefficient of friction at lowest wind loads for maximum effect of the mass damper 1 or to generate a significantly higher coefficient of friction at earthquake excitation, to additionally decelerate the pendulum mass 3 and thus avoid an impact of the pendulum mass 3 in the walls of the TMD chamber, or to obtain a certain friction behavior as a function of the displacement amplitude of the pendulum mass 3.

Alternatively or in addition to the pump device 11, a pressure cartridge or a pressurized lubricant reservoir 21 can also be provided at the bearing 5.

Furthermore, the sliding shoe 8 can have a further joint, which also has a perforated sliding plate, which is also connected to the lubricant circuit via corresponding channels 18. Advantageously, this second sliding plate 22 has a smaller radius of curvature than, for example, the counter surface 9, which is important for the pendulum movement. In the example shown here, there is a third sliding plate 23, which is also connected to the lubricant circuit via channels 18.

As can be seen in FIG. 7, the sliding plate 19 of the sliding shoe 8 does not only have holes 20. Rather, it is also possible that in addition to the holes 20 in the sliding plate 19 notches or elongate recesses 24 are provided, which can also serve to distribute lubricant. It also has a circumferential seal 25 to prevent the lubricant from exiting the side of the sliding plate 19.

As an alternative to a hydrostatic bearing, a bearing 5 designed as a rolling bearing can also be used. Such a bearing is shown, for example, in FIG. 8 in a side view. This also has a pendulum plate 6 with a concave curved bearing surface 7. However, a series of rolling elements 31 are further arranged here in the bearing surface 7. For this purpose, advantageously, the rolling elements 31 are arranged in corresponding cages, which in turn have a curvature corresponding to the bearing surface 7. The sliding shoe 8 then runs on these rolling elements 31.

As an alternative to the displacement of the pendulum plates 6 or the strip-shaped pendulum plate sections 10, they can be rotated or tilted in the plane of the pendulum movement. An example of how this rotation or tilting can be carried out structurally is given in FIG. 9, in which a wedge 13 is arranged under each pendulum plate 6. It is important that the two pendulum plates 6 are tilted in the same way by the angle of rotation α so that a wedge 13 of the same dimension is inserted under each of the two pendulum plates 6. Tilting the pendulum plates 6 outwards causes the centers of curvature M of the bearing surfaces 7 to move outwards in relation to the starting position. This is by the amount by which the pendulum plate 6 is tilted. This amount is shown here as the angle α in FIG. 9. As you can see accordingly, the tilting of the pendulum plates 6 leads to the fact that displacing the rotation centers M apart one another leads to a larger distance a2 between the two centers M compared to the starting situation shown in FIG. 1. Rotating the pendulum plates 6 outwards therefore reduces the frequency of the pendulum movement in the x-direction. If the wedges 13 are arranged just the other way round (not shown), this causes an increase of the natural frequency of the pendulum mass 3.

As an alternative to the wedges 13, it can also be used eccentrics 14 arranged under the pendulum plates 6 with an eccentric upper part 26 and an eccentric lower part 27, as shown in FIG. 10. The angle α with which the bearing surface 7 or the pendulum plate 6 is rotated outwards can be adjusted by rotating the upper eccentric part 26 relative to the lower eccentric part 27.

FIG. 11 shows another variant with which the bearing surface 7 or the pendulum plate 6 can be rotated. Here, inversely curved calottes 15 are arranged under the pendulum plates 6, on which the bearing plates 6 sit. So that these bearing plates 6 sit firmly on the inversely curved calottes 15, their underside has a curvature which is correspondingly negative or convex to that of the calottes 15. If the bearing surface 7 or the pendulum plate 6 is to be rotated, this can now be done by displacing the inverted calotte 15 laterally, as indicated by the horizontal double arrow 28.

A further variant of the adjustment of the angular position of the pendulum plate 6 is shown in FIG. 12. Here the pendulum plate 6 rests on a plurality of pendulum rods 16, at least some of which can be changed in length. These variable-length pendulum rods are assigned to the reference numeral 29 and are arranged in particular on the outer sides of the pendulum plate 6. Thus, the pendulum plate 6 can be tilted around the center by changing the variable-length rods 29.

FIG. 13 schematically shows a further variant for changing the angular position of the sliding plate 6. Here there is a row of lining plates 17 below the pendulum plate 6. There is another joint element 30 between the lining plates 17 and the pendulum plate 6, which ensures that the connection between the lining plates 17 and the curved pendulum plate 6 is fully made. The pendulum plate 6 can be tilted by removing or inserting further lining plates 17 into the stack of lining plates.

### Reference Numerals

1 Mass damper
2 Structure
3 Pendulum mass
4 Damping means
5 Bearing
6 Pendulum plate
7 Bearing surface
8 Sliding shoe
9 Counter surface
10 Strip-shaped pendulum plate section
11 Pump device
12 Adjusting device
13 Wedge
14 Eccentric
15 Inverted calotte
16 Pendulum rod
17 Lining plate
18 Lubricant channel
19 Sliding plate
20 Hole for lubricant
21 Lubricant reservoir/pressure cartridge
22 Second sliding plate of the sliding shoe
23 Third sliding plate of the sliding shoe
24 Elongate recesses in sliding plate 19
25 Lateral seal
26 Eccentric upper part
27 Eccentric lower part
28 Movement arrow for displacement of the calottes
29 Variable-length pendulum rods
30 Joint element
31 Rolling element
R Radius of the bearing surface
RS Pendulum radius of the center of mass
S Center of gravity of the pendulum mass
M Center of curvature of the bearing surface
a1 Average distance between the sliding shoes
a2 Distance between the points M
x First direction
y Second direction
α Angle of rotation

1. A mass damper for reducing vibrations of a structure with a pendulum mass and a damping means, wherein the mass damper has at least three bearings with which the pendulum mass is movably supported on the structure such that it can execute pendulum movements and each of the bearings has at least one pendulum plate with a concave curved bearing surface and a sliding shoe arranged movably thereon with a convex curved counter surface, each sliding shoe for its part is articulately fastened to the pendulum mass, and for all bearings, the bearing surfaces and the associated counter surfaces are curved with a constant radius of curvature and all bearings have a lowest possible friction between the counter surface and the bearing surface, wherein for adjusting the natural frequency of the pendulum mass, for at least two bearings, the relative position of the respective pendulum plates can be changed with respect to one another.

2. The mass damper according to claim 1, wherein the damping means has passive linear viscous damping properties, passive square viscous damping properties and/or controlled damping properties and wherein optionally the mass damper has at least one hydraulic cylinder.

3. The mass damper according to claim 1, wherein at least one bearing has a friction resistance between the counter surface and the bearing surface which is less than 5% of the weight force of the pendulum mass, less than 0.5% of the weight force of the pendulum mass, or less than 0.25% of the weight force of the pendulum mass.

4. The mass damper according to claim 1, wherein the radius of curvature of the bearing surfaces of the pendulum plates corresponds to the required pendulum radius of a freely suspended pendulum mass of the same mass.

5. The mass damper according to claim 1, wherein the bearing surfaces of the pendulum plates and/or the counter surfaces of the sliding shoes are curved cylindrically and/or spherically.

6. The mass damper according to claim 1, wherein for at least one, or optionally each, bearing, the bearing surface and the associated counter surface are curved with the same radius of curvature.

7. The mass damper according to claim 1, wherein at least one bearing has a multi-part pendulum plate, which has a plurality of pendulum plate sections.

8. The mass damper according to claim 7, wherein the pendulum plate sections are strip-shaped with strip-shaped partial bearing surfaces in plain view, of which optionally at least two are arranged at right angles to one another.

9. The mass damper according to claim 8, wherein a sliding shoe with two counter surfaces and a joint being between them is arranged between two, optionally arranged at right angles to one another, strip-shaped pendulum plate sections.

10. The mass damper according to claim 8, wherein for at least one bearing, the pendulum plate sections of the bearing can be displaced and/or tilted relative to one another so that the respective partial bearing surfaces are flush at their upper side after the displacement.

11. The mass damper according to claim 7, wherein for at least one bearing, the pendulum plate sections can be changed in their position relative to one another separately from one another.

12. The mass damper according to claim 7, wherein for adjusting the natural frequency of the pendulum mass, for at least two bearings, the relative position of the respective pendulum plate sections corresponding to one another can be changed with respect to one another.

13. The mass damper according to claim 1, wherein for adjusting the natural frequency, for at least two bearings, the pendulum plates extending longitudinally in the direction of an axis wherein the frequency of the pendulum movement is to be adjusted, can be displaced relative to one another in the direction wherein the axis extends.

14. The mass damper according to claim 1, wherein for adjusting the natural frequency, for at least two bearings, the two pendulum plates can be rotated relative to one another.

15. The mass damper according to claim 14, wherein the rotation takes place about a radius center which is not equal to a radius center of the curved bearing surfaces.

16. The mass damper according to claim 1, wherein at least one bearing is designed as a hydrostatic bearing.

17. The mass damper according to claim 16, wherein at least one bearing designed as a hydrostatic bearing has a pump device generating the hydrostatic effect.

18. The mass damper according to claim 17, wherein at least one bearing designed as a hydrostatic bearing is designed such that it has emergency running properties in the event of failure of the pump device generating the hydrostatic effect.

19. The mass damper according to claim 17, wherein the pump device is designed such that its pumping capacity is controllable for situation-adapted adjusting of the friction of the bearing.

20. The mass damper according to claim 16, wherein at least one bearing designed as a hydrostatic bearing is designed such that it contributes at least temporarily to the damping of the mass damper.

21. The mass damper according to claim 1, wherein the damping means is designed such that its damping force is controllable for adjusting the generation of situation-adapted damping properties.

22. The mass damper according to claim 1, wherein at least one bearing is designed as a rolling bearing or as a rail-guided wheel slide.

23. The mass damper according to claim 22, wherein at least one bearing designed as a rolling bearing or as a rail-guided wheel slide has a sound insulation.

24. The mass damper according to claim 1, wherein it has four bearings with which the pendulum mass is supported on the structure and which are designed such that the position of the pendulum plates can be changed in pairs counter-directed.

25. The mass damper according to claim 1, wherein at least two bearings have a common adjusting device for displacing and/or rotating the respective pendulum plates relative to one another.

26. The mass damper according to claim 25, wherein the adjusting device has at least one wedge, a lining plate, an eccentric, a pendulum rod and/or an inversely curved calotte for rotating the pendulum plate.

27. The mass damper according to claim 25, wherein the adjusting device has a motor drive means for displacing and/or rotating the pendulum plates.

28. A structure with a mass damper according to claim 1, wherein the damping means and the pendulum plates of the bearings of the mass damper are attached to the structure.

29. A method for adjusting the natural frequency of a mass damper according to claim 1, wherein the pendulum plates of the bearings of the mass damper are displaced in a first direction and/or rotated relative to one another until the natural frequency of the pendulum movement of the pendulum mass occurring in this first direction reaches a predetermined target value.

30. The method for adjusting the natural frequency of a mass damper according to claim 29, wherein the pendulum plates of the bearings of the mass damper are displaced in a second direction and/or rotated relative to one another until the natural frequency of the pendulum movement of the pendulum mass occurring in this second direction reaches a predetermined target value.

31. The method for adjusting the natural frequency of a mass damper according to claim 29, wherein the pendulum plates of the bearings of the mass damper are pushed towards one another and/or rotated inwards in order to increase the natural frequency of the pendulum mass.

32. The method for adjusting the natural frequency of a mass damper according to claim 29, wherein the pendulum plates of the bearings of the mass damper are pushed apart one another and/or rotated outwards in order to reduce the natural frequency of the pendulum mass.
